(19) United States
(12) Patent Application Publication
(10) Pub. No.: US 2012/0241066 A1
(43) Pub. Date: Sep. 27, 2012

(54) TIRE CONTAINING AN INTERNAL COMPOSITE COMPRISED OF METAL CORD REINFORCED RUBBER LAYER WITH AUXILIARY BUFFER RUBBER LAYER

(76) Inventor: Paul Harry Sandstrom, Cuyahoga Falls, OH (US)

(21) Appl. No.: 13/070,514

(22) Filed: Mar. 24, 2011

(51) Int. Cl. B60C 9/00

(52) U.S. Cl. 152/451

(57) ABSTRACT

This invention relates to a tire comprised of an assembly of uncured rubber components wherein said assembly includes a circumferential uncured pre-formed internal composite comprised of a combination of at least one uncured rubber layer containing metal cord reinforcement with a high sulfur content and at least one adjoining auxiliary buffer layer of uncured rubber layer having a significantly lower sulfur content and without cord reinforcement. The auxiliary buffer rubber layer(s) with the reduced sulfur content is provided to promote tear resistance and sulfur cure reversion resistance for the composite. In a preferred embodiment, the uncured rubber composite is pre-formed prior to its application to and made a part of the tire assembly of components. The tire assembly is thereafter cured in a suitable mold to form a tire.

### FIELD OF THE INVENTION

This invention relates to a tire comprised of an assembly of uncured rubber components wherein said assembly includes a circumferential uncured pre-formed internal composite comprised of a combination of at least one uncured rubber layer containing metal cord reinforcement with a high sulfur content and at least one adjoining auxiliary buffer layer of uncured rubber layer having a significantly lower sulfur content and without cord reinforcement. The auxiliary buffer rubber layer(s) with the reduced sulfur content is provided to promote tear resistance and sulfur cure reversion resistance for the composite. In a preferred embodiment, the uncured rubber composite is pre-formed prior to its application to and made a part of the tire assembly of components. The tire assembly is thereafter cured in a suitable mold to form a tire.

### BACKGROUND OF THE INVENTION

Pneumatic rubber tires are sometimes prepared with a circumferential internal metal cord reinforced rubber layer which underlies its circumferential rubber tread and is positioned between the tire tread and supporting tire carcass. The metal cord containing rubber layer is sometimes referred to as a belt ply. Such tire construction is well known to those having skill in such art.

The circumferential rubber belt plies, or layers, for this invention contain reinforcement in a form of a plurality of brass coated steel wire cords. The rubber composition of the belt ply is typically comprised of a sulfur curable rubber such as cis 1,4-polyisoprene rubber.

To promote adhesion of the rubber composition to the brass coated steel cord, the rubber composition typically contains a relatively high sulfur content of at least 2.5 phr, such as, for example, in a range of from about 2.5 to about 8, alternately in a range of from about 3 to about 5, phr of free sulfur to both promote adhesion of the rubber composition to the cord reinforcement, and to promote an increase in sulfur cross-link density of the rubber composition.

It is to be appreciated that a portion of the free sulfur contained in the cord reinforced uncured rubber layer(s) would migrate to the surface of the rubber layer and thereby into adjoining rubber layers of the tire tread and/or tire carcass.

A significant aspect of this invention is to evaluate an effect of positioning one or more layers of an auxiliary buffer rubber layer on an upper or lower surface or sandwiched between two of high sulfur-containing metal cord reinforced rubber layers which has a significantly lower free sulfur content to act as a barrier rubber layer to thereby promote a greater tear resistance property, a greater resistance to sulfur cure reversion and, also to absorb a portion of free sulfur which migrated to the surface of the metal cord reinforced rubber layer. Further, it is desired to promote an improvement in interfacial gradation of cured adhesion between the cord reinforced rubber layers, tire tread and/or carcass components of the tire.

In the description of this invention, the term “phr” where used means “parts of material by weight per 100 parts by weight of rubber”. The terms “rubber” and “elastomer” may be used interchangeably unless otherwise indicated. The terms “rubber composition” and “compound” may be used interchangeably unless otherwise indicated.

### SUMMARY AND PRACTICE OF THE INVENTION

In accordance with this invention, a tire is provided which is comprised of an assembly of uncured rubber components wherein said assembly includes a circumferential uncured pre-formed internal composite comprised of a combination of at least one uncured rubber layer of a metal cord reinforcement containing rubber composition with a sulfur content of at least 2.5 phr and at least one adjoining auxiliary buffer layer of uncured rubber layer without cord reinforcement and having a sulfur content of at least 1 phr less than said sulfur content of said metal cord reinforcement-containing rubber layer. The composite is positioned between a circumferential uncured outer rubber tread and supporting inner uncured rubber carcass. In a preferred embodiment, the uncured rubber composite with the auxiliary buffer rubber layer(s) is pre-formed prior to its application to and made a part of the tire assembly of components. The tire assembly is thereafter cured in a suitable mold to form a tire.

In an embodiment of the invention, an uncured tire is provided comprised of an assembly of uncured rubber components including an outer circumferential uncured rubber tread layer and an inner supporting uncured rubber carcass wherein said assembly includes an internal circumferential uncured pre-formed composite positioned between said tire tread and said tire carcass wherein said composite is composed of a combination of at least one uncured basic rubber layer comprised of cis 1,4-polyisoprene rubber and having a free sulfur content of at least 2.5 phr, alternately in a range of from about 3 to about 5 phr and which contains metal reinforcement comprised of brass coated steel cords and at least one adjoining auxiliary buffer layer of uncured rubber having a significantly lower sulfur content of at least 1 phr, alternately at least 1.5 phr, less than said free sulfur content of said basic metal cord reinforced rubber layer, wherein said auxiliary buffer rubber layer does not contain metal cord reinforcement and wherein said auxiliary adjoining buffer rubber layer is positioned on at least one of top, bottom and between two of said metal cord-containing rubber layers.

In further accordance with this invention, a tire is provided comprised of said assembly of rubber components cured in a suitable mold.

To promote adhesion of the cured rubber composition to the brass coated steel cord, the uncured rubber composition of the basic rubber layer typically contains the relatively high free sulfur content.

Because of the significant differential of free sulfur contents between said auxiliary buffer uncured rubber layer(s) and basic metal cord-containing rubber layer, a greater tear resistance and resistance to sulfur cure reversion is promoted for the auxiliary buffer rubber layer(s) and, further, at least a portion of free sulfur migrated to the surface of said basic metal cord-containing rubber layer is absorbed by said auxiliary uncured buffer rubber layer.

In one embodiment of the invention, said basic cord reinforced rubber layer is comprised of:

(A) an uncured metal cord reinforcement-containing rubber composition comprised of, based upon parts by weight per 100 parts by weight rubber (phr):
(1) diene elastomer based rubber comprised of cis 1,4-polyisoprene rubber, and
(2) about 20 to about 60, alternately from about 30 to about 50, phr of reinforcing filler comprised of:
   (a) rubber reinforcing carbon black, or
   (b) precipitated silica, or
   (c) a combination of rubber reinforcing carbon black and 5 to 45 phr of precipitated silica;
(3) coupling agent for said precipitated silica, when said rubber composition contains said precipitated silica, having a moiety reactive with hydroxyl groups (e.g. silanol groups) on said precipitated silica and another different moiety interactive with said cis 1,4-polyisoprene rubber,
(4) optionally, a resinous reaction product of a methylene donor and methylene acceptor compound formed in situ within the rubber composition (formed from the reaction of said methylene donor and methylene acceptor within the rubber composition),
wherein said methylene donor is comprised of hexamethoxymethylmelamine, and
wherein said methylene acceptor is comprised of at least one of unmodified phenol novolac resin and modified phenol novolac resin, resorcinol and mixtures thereof;
(5) optionally, a zirconium salt or cobalt salt comprised of at least one of cobalt naphthenate, and cobalt neodecanoate in an amount of from about 0.2 to about 5 phr and
(6) sulfur in an amount of at least 2.5 phr, alternately in a range of from about 3 to about 5 phr;
(7) at least one cord, preferably a plurality of parallel cords aligned substantially parallel to each other, encapsulated by said cis 1,4-polyisoprene rubber based rubber composition,
wherein said cords are individually comprised of at least one filament, alternately a plurality of cabled (twisted together) filaments,
wherein said filament is comprised of a brass coated steel filament; and

(B) at least one auxiliary buffer rubber layer adjoining said basic metal cord-reinforced rubber layer and positioned as at least one of on top of, on the bottom of said metal cord-reinforced rubber layer and between two of said metal cord-reinforced rubber layers, and

wherein the rubber composition of said auxiliary buffer layer(s) is comprised of, based upon parts by weight per 100 parts by weight rubber (phr):
(1) at least one diene-based rubber wherein said rubber includes cis 1,4-polyisoprene rubber,
(2) about 20 to about 60, alternately from about 30 to about 50, phr of reinforcing filler comprised of:
   (a) rubber reinforcing carbon black, or
   (b) precipitated silica, or
   (c) a combination of rubber reinforcing carbon black and 5 to 45 phr of precipitated silica;
(3) coupling agent for said precipitated silica, when said rubber composition contains said precipitated silica, having a moiety reactive with hydroxyl groups (e.g. silanol groups) on said precipitated silica and another different moiety interactive with said diene based rubber,
(4) sulfur in an amount of at least 1 phr, alternately at least 1.5 phr, less than the sulfur content of said basic metal cord-reinforced rubber layer.

In practice, said auxiliary buffer rubber layer might optionally contain said resinous product of said methylene donor and methylene acceptor compound or said optional zirconium or cobalt salt. It is appreciated that the sulfur for the rubber layers is accompanied by a sulfur cure accelerator such as for example a sulfenamide and, optionally a sulfur cure retarder.

In practice, the amount of the methylene donor compound, namely the methylene donor comprised of hexamethoxymethylmelamine, for the metal cord-reinforced rubber composition may vary from, for example about 0.5 to about 5 phr.

The term “methylene acceptor” is known to those having skill in such art and is used to describe the reactant, or compound with which the methylene donor compound reacts to form what is believed to be an intermediate methylol monomer. It is envisioned that a condensation of the intermediate methylol monomer by formation of a methylene bridge produces a resin material. The initial reactant for which it is envisioned contributes the moiety that later forms the methylene bridge and ultimately the resin is referred to as being the methylene donor compound and the other reactant is referred to as being the methylene acceptor compound. As previously indicated, representative compounds which may be used as a methylene acceptor include phenol novolac resins, including modified phenol novolac resins. Various methylene acceptors are mentioned in, for example, U.S. Pat. Nos. 6,605,670, 6,472,457, 5,945,500, 5,936,056, 5,688,871, 5,665,799, 5,504,127, 5,405,897, 5,244,725, 5,206,389, 5,194,513, 5,030,692, 4,605,696, 4,436,853 and 4,092,455. Examples of modified novolac resins include, for example, cashew nut shell oil and alkyl modified phenol novolac resin such as, for example, SP6700™.

The amount of methylene acceptor compound in the rubber composition may vary, depending somewhat upon the amount of methylene donor compound used as well as the selection of the methylene acceptor compound itself and a desired ratio of methylene donor compound to methylene acceptor compound. For example, the amount of methylene acceptor compound, as a component of said resinous reaction product of said methylene donor and methylene acceptor, may be in a range of from about 0.5 to about 5, alternatively from about 1 to about 3 phr.

A weight ratio of the methylene acceptor compound to methylene donor compound may range, for example, from about 5/1 to about 1/5.

In practice, as indicated, the optional cobalt salt is comprised of at least one of a cobalt neodecanoate and cobalt naphthenate.

The amount of zirconium or cobalt salt, when used in the metal cord-reinforced rubber composition, may vary considerably. For example, for a wire coat rubber composition where the cord is comprised of at least one wire filament, it may range from about 0.2 to about 5 phr.

In practice, representative of sulfenamide primary sulfur cure accelerators for this invention are comprised of cyclohexyl benzothiazole sulfenamide, tertiary butyl benzothiazole sulfenamide or dicyclohexyl benzothiazole sulfenamide. Primary sulfur cure accelerators comprised of cyclohexyl benzothiazole sulfenamide or tertiary butyl benzothiazole sulfenamide are preferred.

A significance of requiring the rubber of the rubber composition of the metal cord reinforced rubber composite to be cis 1,4-polyisoprene rubber, namely cis 1,4-polyisoprene rubber in a form of synthetic or natural polyisoprene rubber, is to promote a relatively high tear strength property and good processability in combination with promoting a relatively low hysteresis (relatively high hot rebound property) for the rubber composition.

A significance of using a combination of methylene donor compound and methylene acceptor compound for the rubber composition of the cord reinforced rubber composite is considered herein to be beneficial to promote high low strain stiffness (G′ storage modulus at 10 percent strain at 100° C.) values for the cured rubber composition and good adhesion of the rubber composition to the reinforcing cord.

A significance of using the optional zirconium or cobalt salt, particularly comprised of the cobalt naphthenate, for the rubber composition of the metal cord reinforced rubber composition is considered herein to be beneficial to promote good cord adhesion particularly where brass or bronze coated steel wire is used for the cord.

A significance of using precipitated silica reinforcement, in combination with a silica coupling agent, is considered herein to be beneficial to promote low hysteresis for the rubber composition.

The practice of this invention is further illustrated by reference to the following examples which are intended to be representative rather than restrictive of the scope of the invention. Unless otherwise indicated, all parts and percentages are by weight.

### Example I

Rubber samples were prepared to evaluate use of free sulfur in amounts of 4, 3.2 and 2.4phr, respectively, in three rubber Samples A, B and C for use as brass coated steel cord reinforced circumferential rubber belt plies for a vehicular tire.

As indicated above, the rubber samples are referred to herein as rubber Samples A, B and C with 5, 4 and 3 phr of sulfur curative (which is 80 percent active sulfur), respectively.

The rubber compositions were prepared by blending the ingredients in an internal rubber mixer in a series of sequential mixing steps while sheeting out the rubber mixtures and cooling to a temperature below 40° C. between mixing steps. The sequential mixing steps were comprised of a first non-productive mixing step followed by a second non-productive mixing step and thence by a productive mixing step (in which sulfur and accelerators were added).

Such sequential non-productive and productive rubber mixing steps are well known to those having skill in such art.

The basic formulation for the rubber Samples A, B and C is presented in the following Table 1 in terms of parts by weight unless otherwise indicated.

TABLE 1

| | Parts |
|---|---|
| First Non-Productive Mixing Step (NP1) | |
| Natural cis 1,4-polyisoprene rubber¹ | 100 |
| Carbon black (N347)² | 60 |
| Tackifier resin³ | 1 |
| Methylene acceptor (resorcinol) | 2 |
| Rubber processing oil⁴ | 1 |
| Fatty acid⁵ | 2 |
| Second Non-Productive Mixing Step (NP2) | |
| This step is for additional mixing without addition of ingredients | |
| Productive Mixing Step (P) | |
| Sulfur (80% active) | 5, 4, 3 |
| Sulfur cure accelerators/retarder⁶ | 1.5 |
| Zinc oxide | 3 |
| Methylene donor (Hexamethoxy methylmelamine) | 3 |
| Antioxidant | 0.8 |

¹Natural rubber, TSR10
²Rubber reinforcing carbon black (N347), an ASTM designation
³Phenol/formaldehyde resin
⁴Naphthenic/paraffinic rubber processing oil
⁵Blend of fatty acids comprised primarily of stearic acid, palmitic acid and oleic acid
⁶Sulfenamide accelerator and N-cyclohexylthiophthalimide sulfur cure retarder

Cobalt naphthenate (10.5 percent by weight cobalt) may be added, if desired, to the rubber composition.

The following Table 2 illustrates cure behavior and various physical properties of rubber Samples A, B and C based upon the basic formulation of Table 1. The rubber samples were sulfur cured for about 32 minutes at about 150° C.

TABLE 2

| | Rubber Samples | | |
|---|---|---|---|
| | A | B | C |
| Sulfur Curative | | | |
| Sulfur (80% active), phr | 5 | 4 | 3 |
| Net active free sulfur content (phr) | 4 | 3.2 | 2.4 |
| Properties | | | |
| Rheometer, 150° C. (MDR)¹ | | | |
| Maximum torque (dNm) | 45.7 | 43.9 | 40.9 |
| Minimum torque (dNm) | 2.8 | 3.1 | 3.0 |
| Delta torque (dNm) | 42.9 | 40.8 | 37.9 |
| T90, minutes | 13.9 | 13.2 | 13 |
| Stress-Strain: ATS, 32 min, 150° C.² | | | |
| Tensile strength (MPa) | 14.3 | 12.4 | 12.7 |
| Elongation (ultimate) at break (%) | 339 | 346 | 363 |
| 300% modulus, ring (MPa) | 13.9 | 11.3 | 10.9 |
| Wire cord adhesion³ 23° C., (N) | | | |
| Force (N), original, 32 minutes at 150° C. | 570 | 491 | 452 |
| Percent rubber coverage of wire (%) | 75 | 40 | 30 |
| Force (N), aged 20 days in water at 90° C. | 632 | 163 | 124 |
| Percent rubber coverage of wire (%) | 50 | 35 | 10 |
| Force (N), aged 10 days in nitrogen, 120° C. | 719 | 649 | 378 |
| Percent rubber coverage of wire (%) | 90 | 80 | 15 |
| Tear strength⁴, (N) at 95° C. | 60 | 74 | 85 |

¹Data obtained according to Moving Die Rheometer instrument, model MDR-2000 by Alpha Technologies, used for determining cure characteristics of elastomeric materials, such as for example Torque and T25.
²Data obtained according to Automated Testing System instrument by the Instron Corporation which incorporates six tests in one system. Such instrument may determine ultimate tensile, ultimate elongation and modulii.
³Standard wire and textile cord adhesion test (SWAT) conducted by embedding brass coated wire cord in the rubber composition. The rubber/cord samples were then cured at the indicated temperatures. The respective cords in the rubber samples were subjected to a pull-out test according to ASTM D2229-73. The results of the pull-out tests are expressed in Newtons. The percentage of rubber coverage of the wire cord is reported where 100 percent coverage is desirable although difficult to obtain. The wire cord was a brass coated steel wire.
⁴Data obtained according to a peel strength adhesion test to determine interfacial adhesion between two samples of a rubber composition. In particular, such interfacial adhesion is determined by pulling one rubber composition away from the other at a right angle to the untorn test specimen with the two ends of the rubber compositions being pulled apart at a 180° angle to each other using an Instron instrument. The area of contact at the interface between the rubber samples is facilitated by placement of a Mylar ™ film between the samples with a cut-out window in the film to enable the two rubber samples to contact each other following which the samples are vulcanized together and the resultant composite of the two rubber compositions are used for the peel strength test.

It can be seen from Table 2 that, as the free sulfur content increased from 2.4 to 4 phr, the wire adhesion beneficially increased 26 percent from 452 to 570 Newtons, the aged-in-water wire adhesion beneficially increased 409 percent from 124 to 632 Newtons and the aged-in-nitrogen wire adhesion beneficially increased 90 percent from 378 to 719 Newtons. It is also shown in this data that the percent of rubber coverage is also increased by increasing the free sulfur content of the rubber compositions, which is also favorable for maintaining good adhesion to brass coated steel wire.

In summary, it can be seen from Table 2 that, for the rubber composition, reducing the active (net) sulfur content from 4 phr (for rubber Sample A) to 2.4 phr (for rubber Sample C) caused a sharp decrease in the brass coated steel wire adhesion and percent rubber coverage, but also provided significantly higher tear strength for rubber Sample C with the lower active sulfur content of 2.4 phr.

Accordingly, it can be seen that keeping the active sulfur content below 2.5 phr (namely in rubber Sample C) provided improved (increased) tear strength with a lower wire adhesion and lower rubber coverage.

It is concluded that the relatively high active sulfur content rubber composition (namely as rubber Sample A) can be used for the brass coated steel wire for improved wire adhesion, but that the lower active sulfur content rubber composition (namely as rubber Sample C) can be used to improve tear strength and therefore be suitable for the auxiliary buffer rubber layer adjacent to the basic higher sulfur content-containing wire cord reinforced rubber composition (namely rubber Sample A) in a sense of providing a buffer rubber layer of beneficially increased tear resistance and also to absorb a portion of free sulfur migrated to the surface of the basic wire reinforced rubber composition.

### Example II

An additional rubber sample was prepared in order to evaluate use of a much lower active free sulfur content of only 0.8 phr for the rubber composition (referred to herein as rubber Sample D).

The rubber composition was prepared in the manner of Example I.

The basic formulation for the rubber Sample D is presented in the following Table 3 in terms of parts by weight unless otherwise indicated.

TABLE 3

| | Parts |
|---|---|
| Non-Productive Mixing Step (NP1) | |
| Natural cis 1,4-polyisoprene rubber | 100 |
| Carbon black (N347) | 45 |
| Tackifier resin | 2 |
| Rubber processing oil | 3 |
| Fatty acid | 2 |
| Productive Mixing Step (P) | |
| Sulfur (100% active) | 0.8 |
| Sulfur cure accelerators/retarder | 2.7 |
| Zinc oxide | 1.5 |
| Antioxidant | 1 |

The indicated materials in Table 1 were used except for the methylene acceptor and donor materials. A cobalt salt was not used.

The following Table 4 illustrates cure behavior and various physical properties of rubber Sample D based upon the basic formulation of Table 3. The rubber samples were sulfur cured for about 32 minutes at about 150° C.

TABLE 4

| | Rubber Sample D |
|---|---|
| Sulfur curative (100% active), phr | 0.8 |
| Properties | |
| Rheometer, 150° C. (MDR) | |
| Maximum torque (dNm) | 11.4 |
| Minimum torque (dNm) | 1.0 |
| Delta torque (dNm) | 10.4 |
| T90, minutes | 9.8 |
| Stress-Strain: ATS, 32 min, 150° C. | |
| Tensile strength (MPa) | 19.5 |
| Elongation (ultimate) at break (%) | 527 |
| 300% modulus, ring (MPa) | 9.5 |
| Tear strength, (N) at 95° C. | 125 |

The indicated tests were conducted in the manner of Example I

It can be seen from Table 4 that the much lower sulfur content for the rubber composition yielded a significantly higher tear strength of 125 Newtons and, from results indicated in Examples I and II, would be expected to provide a significantly lower wire adhesion value.

It is concluded that use of the lower sulfur content in the cis 1,4-polyisoprene rubber based rubber composition will yield a higher tear strength for the rubber composition than similar rubber composition having a significantly higher free sulfur content with an expected higher adhesion to the brass surface of the brass coated steel wire.

This unique choice of high and low sulfur contents in the rubber composition around and in contact with the brass coated steel wire would allow attainment of high adhesion to the brass coating and also promote improved rubber composition integrity relating to its tear strength.

### BRIEF DESCRIPTION OF DRAWINGS

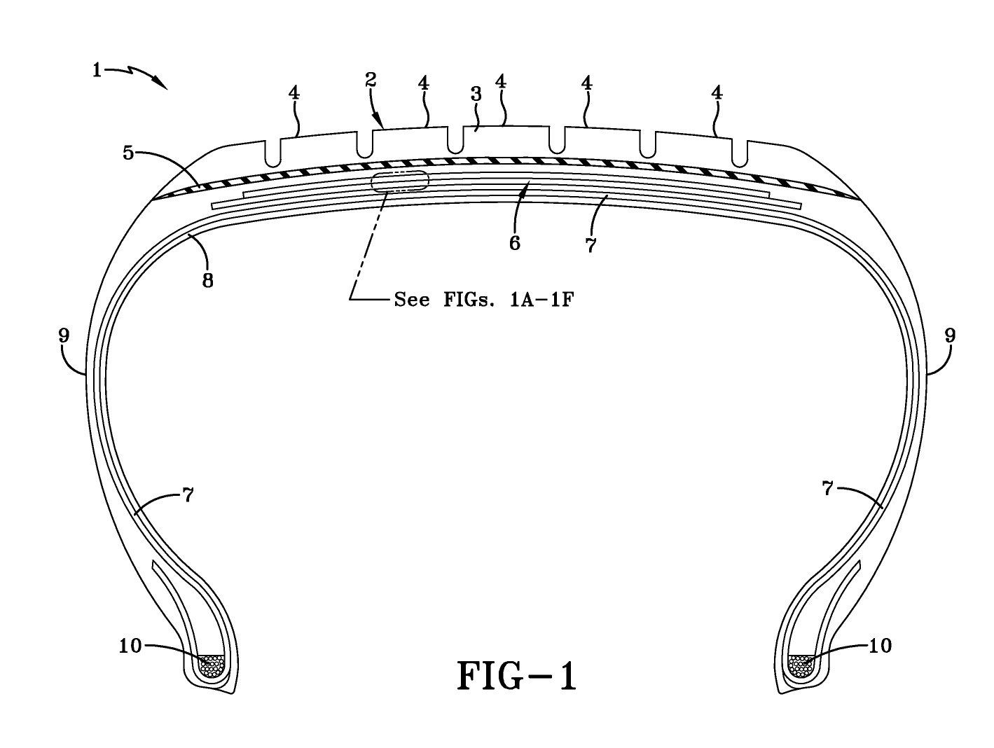

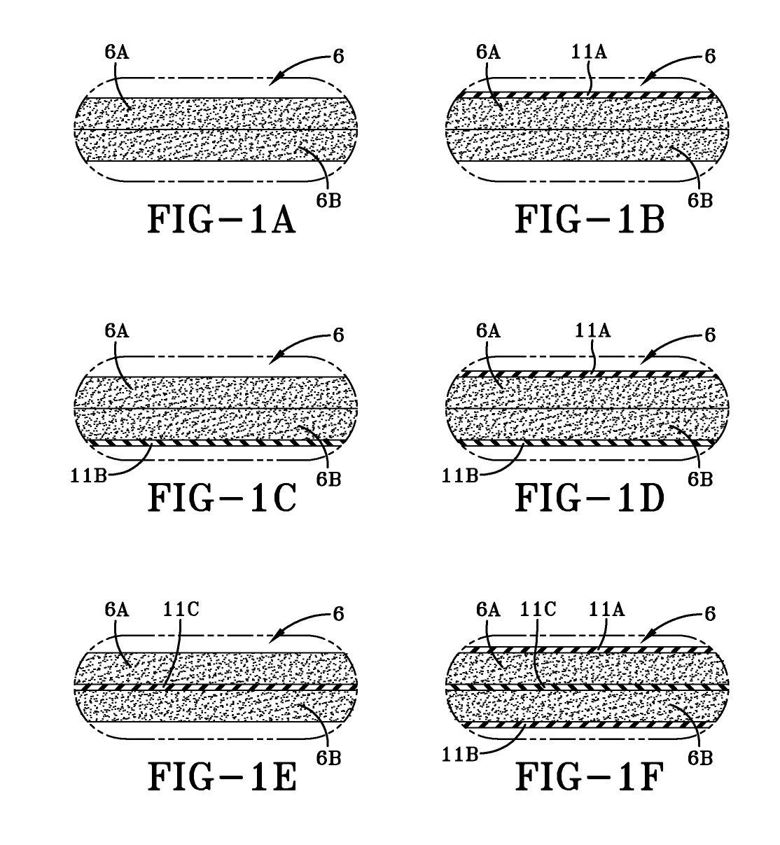

The Drawings depict a tire cross-section as FIG. 1 (FIG. 1) and inserts from the tire cross-section as FIGURES (FIGS. 1A through 1F.

### THE DRAWINGS

FIG. 1 depicts a tire cross-section (1) comprised of a circumferential rubber tread (2) configured with an outer tread cap rubber layer (3), having lugs, grooves and running surface (4), and underlying tread base rubber layer (5). The tire (1) is depicted with a sidewall (9) and spaced apart beads (10), carcass plies (7) and inner liner (8). Positioned between the tread (2) and carcass (7) are two circumferential belt layers (6).

A portion of the belt layers (6) is depicted in expanded views FIGS. 1A through 1F, each with two belt layers composed of brass coated steel cord reinforced rubber layers 6A and 6B. For this drawing depiction, the rubber of layers (6A) is composed of uncured natural cis 1,4-polyisoprene rubber with a free sulfur content of about 3 phr.

FIG. 1A depicts the belt (6) configured with dual cord reinforced layers 6A and 6B. It is contemplated that a portion of the free sulfur migrates to the surfaces of belt layers (6A) and (6B).

FIGS. 1B through 1F depict the belt (6) with one or more uncured buffer rubber layer(s), namely (11A), (11B) and (11C), which contain only 2 phr of free sulfur and therefore 1 phr less than the free sulfur content of the cis 1,4-polyisoprene based rubber composition of the belt layers (6A) and (6B).

It is contemplated that the buffer rubber layers (11A) and (11B), because of their reduced free sulfur content, act in the nature of buffer rubber layers to provide significantly increased tear resistance and, also, to absorb a portion of the migrated free sulfur at the interface between the belt (6) and buffer layers (11A) and (11B) to thereby insulate the tire tread (2) and/or tire carcass (7) from excess interfacial migrated free sulfur from the belt (6).

For FIG. 1B, the buffer rubber layer (11A) is positioned on top of the belt (6), namely on top of belt layer (6A), to thereby insulate the tire tread (2), namely the tread base layer (5), from excess interfacial migrated free sulfur from the belt (6), namely from belt layer (6A).

For FIG. 1C, the buffer rubber layer (11B) is positioned on the bottom of the belt (6), namely on the bottom of belt layer (6B), to thereby insulate the tire carcass (7), namely the carcass plies, from excess interfacial migrated free sulfur from the belt (6), namely from belt layer (6B).

For FIG. 1D, the buffer rubber layers (11A) and (11B) are individually positioned on top and bottom, respectively, of the belt (6), namely on top of belt layer (6A) and bottom of belt layer (6B), to thereby insulate both the tire tread (2), namely the tread base layer (5), and tire carcass (7) from excess interfacial migrated free sulfur from the belt (6), namely from belt layers (6A) and (6B), respectively.

For FIG. 1E, the buffer rubber layer (11C) is positioned between, namely sandwiched between, the belt layers (6A) and (6B) of the belt (6) to thereby insulate the belt layers (6A) and (6B) from excess interfacial migrated free sulfur generated by each other.

For FIG. 1F, the buffer rubber layer (11A) is positioned on top of the belt (6), namely on top of belt layer (6A), the buffer rubber layer (11B) is positioned on the bottom of the belt (6), namely on bottom of belt layer (6B) and buffer rubber layer (11C) is positioned between belt layers (6A) and (6B), to thereby:

(A) insulate the tire tread (2), namely the tread base layer (5), from excess interfacial migrated free sulfur from the belt (6), namely from belt layer (6A),

(B) insulate the tire carcass (7), namely the carcass plies, from excess interfacial migrated free sulfur from the belt (6), namely from belt layer (6B), and

(C) insulate the belt layers (6A) and (6B) from excess interfacial migrated free sulfur generated by each other.

While certain representative embodiments and details have been shown for the purpose of illustrating the invention, it will be apparent to those skilled in this art that various changes and modifications may be made therein without departing from the spirit or scope of the invention.

What is claimed is:

1. A tire comprised of an assembly of uncured rubber components wherein said assembly includes a circumferential uncured pre-formed internal composite comprised of a combination of at least one uncured rubber layer of a metal cord reinforcement containing rubber composition with a sulfur content of at least 2.5 phr and at least one adjoining auxiliary buffer layer of uncured rubber layer without cord reinforcement and having a sulfur content of at least 1 phr less than said sulfur content of said rubber composition of said metal cord reinforcement-containing rubber layer,
wherein said composite is positioned between an outer circumferential uncured rubber tread and an supporting inner uncured rubber carcass.

2. The uncured tire assembly of claim 1 wherein the said metal cord of said metal cord reinforcement-containing rubber layer of said internal rubber composite is a brass coated metal cord.

3. The uncured tire assembly of claim 1 wherein, said composite is comprised of:
(A) said metal cord reinforced rubber layer is comprised of, based upon parts by weight per 100 parts by weight rubber (phr):
(1) diene elastomer based rubber comprised of cis 1,4-polyisoprene rubber, and
(2) about 20 to about 60, alternately from about 30 to about 50, phr of reinforcing filler comprised of:
(a) rubber reinforcing carbon black, or
(b) precipitated silica, or
(c) a combination of rubber reinforcing carbon black and 5 to 45 phr of precipitated silica;
(3) coupling agent for said precipitated silica, when said rubber composition contains said precipitated silica, having a moiety reactive with hydroxyl groups on said precipitated silica and another different moiety interactive with said cis 1,4-polyisoprene rubber,
(4) optionally, a resinous reaction product of a methylene donor and methylene acceptor compound formed in situ within the rubber composition,
wherein said methylene donor is comprised of hexamethoxymethylmelamine, and
wherein said methylene acceptor is comprised of at least one of unmodified phenol novolac resin and modified phenol novolac resin, resorcinol and mixtures thereof;
(5) optionally, a zirconium salt or cobalt salt comprised of at least one of cobalt naphthenate, and cobalt neodecanoate in an amount of from about 0.2 to about 5 phr,
(6) sulfur in an amount of at least 2.5 phr, and
(7) at least one metal cord encapsulated by said cis 1,4-polyisoprene rubber based rubber composition,
wherein said cords are individually comprised of at least one filament,
wherein said filament is comprised of a brass coated steel filament; and
(B) at least one auxiliary buffer rubber layer adjoining said metal cord-reinforced rubber layer and positioned as at least one of on top of, on the bottom of said metal cord-reinforced rubber layer and between two of said metal cord-reinforced rubber layers, and
wherein the rubber composition of said auxiliary buffer layer(s) is comprised of, based upon parts by weight per 100 parts by weight rubber (phr):
(1) at least one diene-based rubber wherein said rubber includes cis 1,4-polyisoprene rubber,
(2) about 20 to about 60 phr of reinforcing filler comprised of:
(a) rubber reinforcing carbon black, or
(b) precipitated silica, or
(c) a combination of rubber reinforcing carbon black and 5 to 45 phr of precipitated silica;
(3) coupling agent for said precipitated silica, when said rubber composition contains said precipitated silica, having a moiety reactive with hydroxyl groups on said precipitated silica and another different moiety interactive with said diene based rubber,
(4) sulfur in an amount of at least 1 phr less than the sulfur content of said basic metal cord-reinforced rubber layer.

4. The uncured tire assembly of claim 1 wherein the said metal cord of said metal cord reinforcement-containing rubber layer of said internal rubber composite is a plurality of brass coated metal cords positioned in a substantially parallel configuration to each other.

5. The uncured tire assembly of claim 3 wherein the said metal cord of said metal cord reinforcement-containing rubber layer of said internal rubber composite is a plurality of brass coated metal wire filaments cabled together.

6. The uncured tire assembly of claim 1 wherein the said metal cord reinforcement-containing rubber layer of said internal rubber composite contains from about 3 to about 5 phr of free sulfur.

7. The uncured tire assembly of claim 1 wherein said adjoining auxiliary rubber layer of said composite contains at least 1.5 phr less of free sulfur content than sulfur content of said rubber composition of said metal cord reinforcement-containing rubber layer.

8. The uncured tire assembly of claim 1 wherein said composite contains two of said metal cord reinforcement-containing rubber layers.

9. The uncured tire assembly of claim 1 wherein said auxiliary rubber layer of said composite is positioned on top of and adjoining said metal cord-reinforcement containing rubber layer.

10. The uncured tire assembly of claim 9 wherein said auxiliary rubber layer of said composite is positioned between said metal cord-containing rubber layer and said tire tread rubber layer.

11. The uncured tire assembly of claim 1 wherein said auxiliary rubber layer of said composite is positioned on the bottom of and adjoining said metal cord-reinforcement containing rubber layer.

12. The uncured tire assembly of claim 11 wherein said auxiliary rubber layer of said composite is positioned between said metal cord-containing rubber layer and said tire carcass.

13. The uncured tire assembly of claim 1 wherein said composite contains two of said metal cord reinforcement-containing rubber layers and wherein said auxiliary rubber layer of said composite is positioned between and adjoining said metal cord-containing rubber layers.

14. The uncured tire assembly claim 1 wherein said uncured rubber composite is pre-formed prior to its application to and made a part of the tire assembly of components.

15. A tire comprised of a sulfur cured tire assembly of claim 1.

16. A tire comprised of a sulfur cured tire assembly of claim 3.

17. A tire comprised of a sulfur cured tire assembly of claim 9.

18. A tire comprised of a sulfur cured tire assembly of claim 11.

19. A tire comprised of a sulfur cured tire assembly of claim 13.

20. A tire comprised of a sulfur cured tire assembly of claim 14.
